(19) United States
(12) Patent Application Publication
(10) Pub. No.: US 2005/0274759 A1
(43) Pub. Date: Dec. 15, 2005

(54) Car cantilever platform (C.C.P.)

(76) Inventor: Joseph H. Kircher, Mooresville, NC (US)

Correspondence Address: Joseph H. Kircher, 123 Market Road, Mooresville, NC, 28115, US

(21) Appl. No.: 10/854,684

(22) Filed: May 26, 2004

(51) Int. Cl. B60R 7/00; B60R 9/00; B60R 11/00

(52) U.S. Cl. 224/499

(57) ABSTRACT

A cargo carrier with a hitch bar permanently fixed to the rear chassis of a vehicle, consisting of a structural platform, attached at both extremities of the hitch bar with two pullout hitch pins. A platform which, when attached in a specific hole combination can be set with horizontal cantilevers parallel to the road or, in another hole combination, can be folded vertically and latched to the rear of the vehicle or can be completely removed and stored by removing the hitch pins. A platform that is light enough for one person to handle due to its size and weight A self contained platform which can be used with a cart and a modified hitch bar. Such a platform is a definite advancement and improvement in regards to transportation and safety.

### BACKGROUND OF THE INVENTION

The field of this invention relates to a medium sized, cargo carrier for vehicles, and in particular, to an assembly of a hitch mounted cross bar, permanently fastened on the rear bottom of a Jeep. Such a cross bar allows the attachment of a wire rod welded, basket platform in two hitch bar extremities. This cross bar also allows two possible modes when traveling, either affixed horizontally when in use, or vertically when temporally not in use The platform can also be completely removed from the cross bar and stored. One person can handle its weight and size.

### PRIOR ART

The following patents were reviewed:

U.S. Pat. Nos. 4,221,3111; 4,777,1926; 4,811,3584; 5,413,260; 5845,832; 5,853,278; and 6,202,909

After evaluation of the content of these patents, the present proposed invention differs advantageously from them, both in the simplicity and in robustness of the present patent, as well as in its versatility.

The closest patents to the one proposed are U.S. Pat. Nos. 4,813,564 and 6,202,909.

U.S. Pat. No. 4,813,584 shows a similar cantilevered, platform cargo carrier, yet the platforms central support is succinct to the load distribution. This does not compare to the C.C.P., which is supported at both extremities with a strong crossbar.

U.S. Pat. No. 6,202,909 was compared to the proposed patent and the draw bar is weak, making it more flexible to carry the cargo, yet decreasing the stability. Because of this instability, the carrier could possibly be thrown off during highway travel.

### BRIEF SUMMARY OF THE INVENTION AREA

Cargo carriers are widely employed to expand the carrying capacity of a vehicle, yet maintain as much comfort as possible within the passenger area. For several decades roof carriers were used, but for the last 15 years they have been mostly abandoned and replaced by light cantilever carriers outfitted on a center modified hitch bar. The present disclosed invention similarly enters into these qualifications, but is stronger and accepts a greater and heavier cargo load. It is also more versatile and convenient in high traffic circumstances. The present invention relates to a structurally strong detachable rear car platform, welded of steel. Yet, it is light enough for the average person to install on a transfer hitch bar, which is permanently bolted to the rear chassis of the car. Such a platform can be horizontally set parallel to the road for cargo use or hinged and latched in a vertical position parallel to the rear of the car. This will make travelling and parking easier when the platform is not being used for cargo. Such a platform can also be detached from the vehicle and stored. Another value of the platform is its secondary use of being assembled on a special hand carrier, used to manually transport garden materials or any other cargo too bulky to handle.

The major originality of the proposed invention is the three hole articulation, drilled on both sides of the platform, and matching the two sets of two holes drilled on the side of the suspension transfer bar and the two clevis hitch pins on each side that connects the platform to the transfer bar. One of the pins is used as a pivot and the other acting in a locked position.

The cantilevered system is safe for highway use at a maximum safe speed up to approximately a 200-pound cargo load. The platform, which has two rear grilled floor sections, allows them to be hinged to the front latched one. As the platform is raised vertically, the cars rear field of view remains open through the rear car window. Two sets of directional and brake lights are attached to the platform, so that in any position the safety driving code is observed. In the vertical position, a replica of the license plate is attached to the back of the platform

### BRIEF DESCRIPTION OF THE DRAWINGS

Sheet 1

FIG. 1-1 shows a perspective of a jeep with the platform anchored to the car and horizontally set parallel to the road.

FIG. 1-2 shows a perspective of the platform with the anchored side-plate details on one side for the horizontal position.

FIG. 1-2a shows a perspective of the platform with the anchored side-plate details on one side for the vertical position.

FIG. 1-3 shows a partial perspective of the platform with a cargo tie attached to the platform.

Sheet 2

FIG. 2-1 shows a similar perspective to FIG. 1-1 with the platform horizontal, but with the two rear grills folded back and latched onto the front one.

Sheet 3

FIG. 3-1 shows a perspective of the positioning of the platform, latched in a vertical position that is very close and parallel to the rear of the Jeep when it is not in use.

FIG. 3-2 shows the vertical position of the security latch, consisting of a combination lock.

Sheet 4 Shows a Perspective of the Structural Platform and its Hitch Bar Weldments.

FIG. 4-1 shows a hitch bar self sub-assembly, along with the details.

FIG. 4-2 shows the platform's self contained, sub assembly, with one grill partially folded.

Sheet 5 Shows an Orthographic Projection of the Hitch Bar.

FIG. 5-1 shows a detailed top view of the hitching bar anchored to the Jeep's chassis.

FIG. 5-2 shows the end elevation of the FIG. 5-1 view set for the platforms horizontal position.

FIG. 5-3 shows an end view similar to FIG. 5-2, but set for vertical positioning of the platform.

FIG. 5-4 shows the pullout hitch pin with its safety cutting pin details.

Sheet 6 Shows an Auxiliary Use of the Platform.

FIG. 6-1 shows a perspective of a cart, which can be used for many varied work applications.

FIG. 6-2 shows a perspective of the platform detached from a hand cart carrier.

FIG. 6-3 shows a horizontal side view of the platform of the cart at rest, and forming a tripod with the two wheels and the leg.

FIG. 6-4 shows the platform rotated 90° to a vertical position from the cart, allowing rapid dumping of loose material with the use of the cover.

### DETAILED DESCRIPTION

Sheet 1

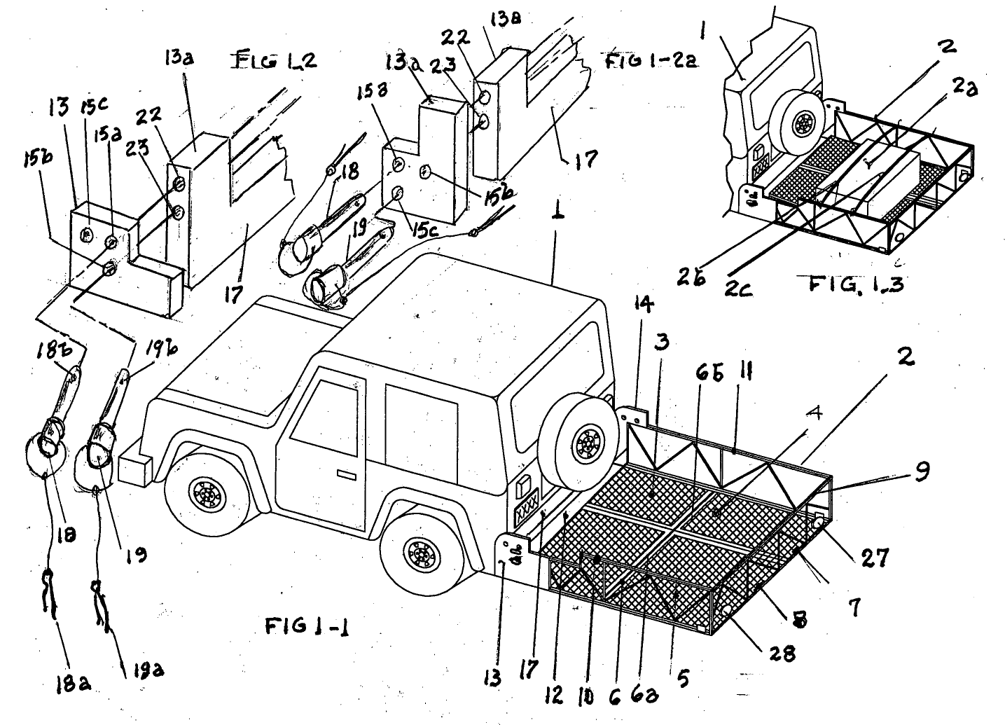

FIG. 1-1 shows a perspective of a Jeep 1, outfitted with a car cantilever platform 2, (Abbreviated as C.C.P.). The platform assembly 2 is manufactured from light structural members welded together to form the platform. The layout of the bottom grill section 3 is permanently welded to the platform frame. Grills 4 and 5 are welded to a hinges 6a and 6b, which are themselves welded to the bottom central beam 6. These grills are snap-latched by two formed springs 7 & 8. The bottom grills of the platform are contoured by three sides of welded profiled rod, a rear one 9, one on the right side 10 and one on the left side 11. A front plate 12 closes the front of the platform. This gives it the rigidity to line up with the transfer hitch bar 17. Also, on the front of each side 10 & 11, a welded plate 13 on the right and 14 on the left, are drilled with three holes aligned from plate to plate with each other. These three holes match the two holes of the transfer bar 17, both in size and space. The transfer bar and the plates 13 and 14 are connected by two hitch pins on both sides, which are secured by cutter hairpins.

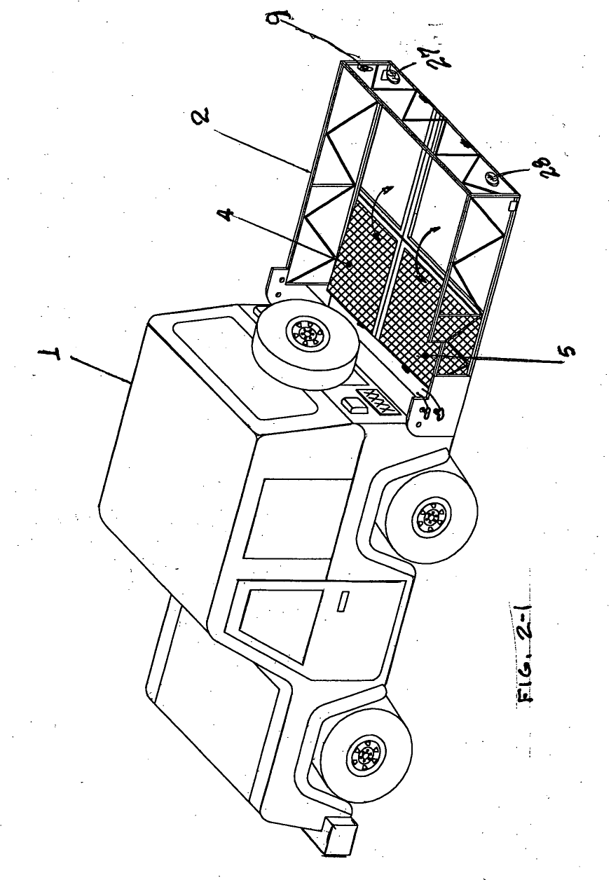

FIG. 1-2 shows a partially exploded perspective of the end plate and the horizontal setting, with the hitch bar and hitch pin aligned. Plate 13 has a set of holes 15a, 15b, and 15c facing the hitch bar subassembly 17, partially shown with a rising boss 13a, which is drilled with two holes 22 & 23. Each pin 18 & 19 connects the plate 13 with the hitch bar 17, by inserting pin 18 through hole 15a and hole 22. Pin 19 is inserted through hole 15b and hole 23. The cutter pins 18a & 19a are inserted through the small holes in 18b & 19b. Symmetrically, the opposite end of the hitch bar boss 14a is connected with plate 14,shown on Sheet 4. Hitch pins 20 & 21 are inserted through plate 14, holes 16a, and 16b through the boss 14a holes 22a and 23a. The pins are then secured by cutter pins 20a & 21a that are inserted into holes 20b & 21b.

FIG. 1-2a shows a partially exploded perspective of the end plate and the vertical setting, with the hitch bar and hitch pin aligned. Plate 13 has a set of holes 15a, 15b, and 15c facing the hitch bar subassembly 17, partially shown with a rising boss 13a, which is drilled with two holes 22 & 23. Each pin 18 & 19 connects the plate 13 with the hitch bar 17, by inserting pin 18 through hole 15a and hole 22. Pin 19 is inserted through hole 15c and hole 23, the same as FIG. 1-2. The cutter pins 18a & 19a are inserted through the small holes 18b & 19b. Hitch pins 20 & 21 are inserted through plate 14, holes 16a, and 16c through the boss 14a holes 22a and 23a. The pins are then secured by cutter pins 20a & 21a, which are inserted into holes 20b-21b.

FIG. 1-3 shows a detailed perspective of the platform assembly installed at the rear of the Jeep, in a horizontal mode with cargo 2a tied to the platform, secured by stretchy straps 2b and 2c.

Sheet 2

FIG. 2-1 shows a perspective of the Jeep, and its platform, attached securely with the two rear grills 4 & 5 folded back onto grill 3 and latched to a metal plate 12. This allows a path of clear vision through the rear window as the platform is raised into a vertical position. Two sets of standard turn signals 28 & 27 are installed on the rear platform 9 and connected to the Jeep's lighting system.

Sheet 3

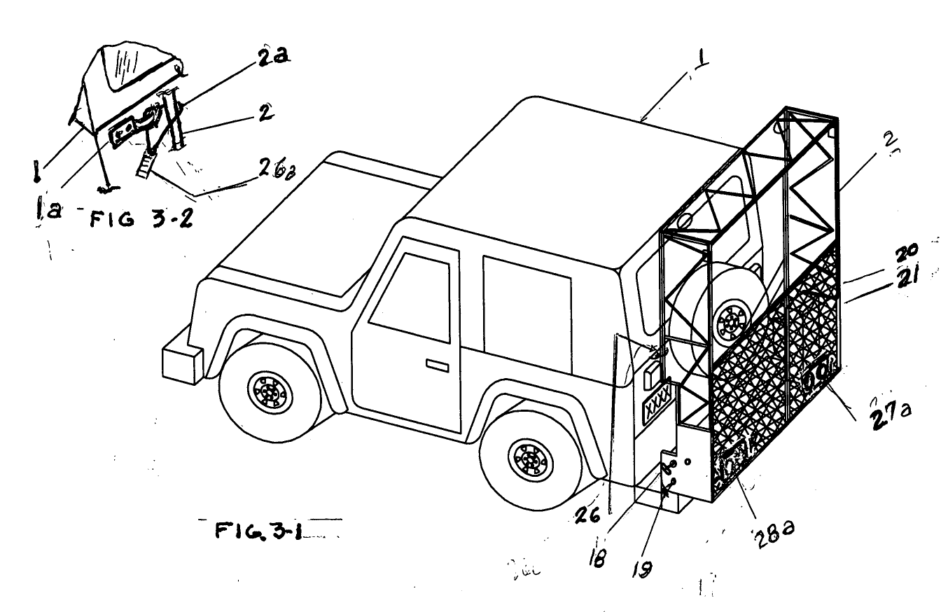

FIG. 3-1 shows the platform 2 raised in a vertical position, both parallel and close to the rear of the Jeep 1. Two pullout hitch pins 18 and 19 are shown. Hitch pins 20 and 21 on the opposite side are also inserted (not shown) and anchored to bar 17. A supplementary latch 26 is on one side, allowing freedom from vibration and acting as a safety from robbery. (see details on FIG. 3-2). Also, in order to assure proper light visibility, a set of two signal lights 27a and 28a are assembled to the bottom rear of the frame.

FIG. 3-2 also shows an anchoring bracket 1a, attached to the right side of the platform frame 2 by a cable 2a, and closed by a combination lock 26a.

Sheet 4

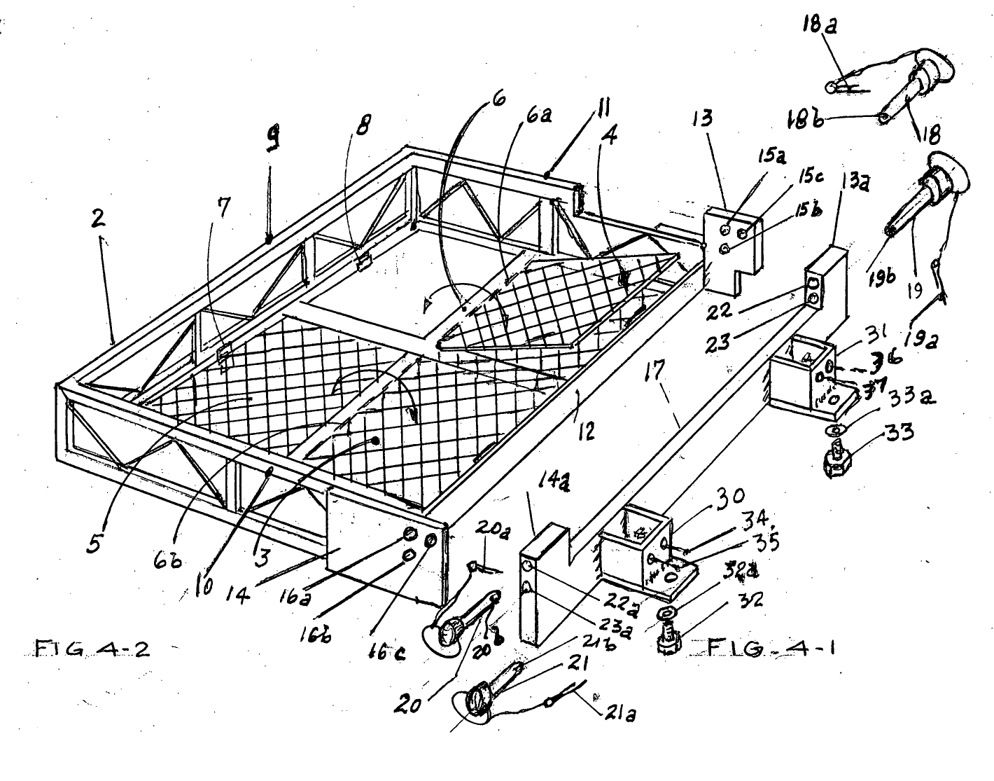

FIG. 4-1 shows an exploded perspective of the hitch bar 17, which provides the welded brackets 30 & 31 which are used to anchor the bar to the rear chassis of the Jeep. These are bolted underneath with large hex bolts 32 & 33, and are secured with lock washers 32a & 33a. These bolts are threaded in an insert that is integrally welded to the chassis (not shown). In addition, four more hex bolts 34, 35, 36 & 37 anchor the bar to the rear upright, chassis edge. The hitch bar 17 has two raised bosses 13a & 14a which are drilled longitudinally with two holes at each end 22 & 23. The length of the bar 22a & 23a fits the space between the inside faces of plates 13 & 14, so that the holes of the plate match the ones of the bar to allow insertion of pullout hitch pins 18, 19, 20 & 21.

FIG. 4-2 shows a top perspective of platform 2, which in turn shows its welded sidewalls 9, 10 & 11 and plate 12. It also shows the three grills with 3 permanently welded to the frame and 2 grills 4 & 5 individually hinged on center hinges 6a & 6b, themselves welded on a center beam 6. The grill 4 is shown partially folded. Also shown are two latches 7 & 8 that anchor a snap action to the grills 4 & 5 to the edge 9 when recessed.

Drawing 4-2 also shows the rectangular as well as tubular welded, edged framing with the welded grill 3, which maintains the platform's rigidity.

Sheet 5 Shows an Orthographic Projection of Three Views of the Platform Hitch Bar 17, and the Chassis 1 Connection.

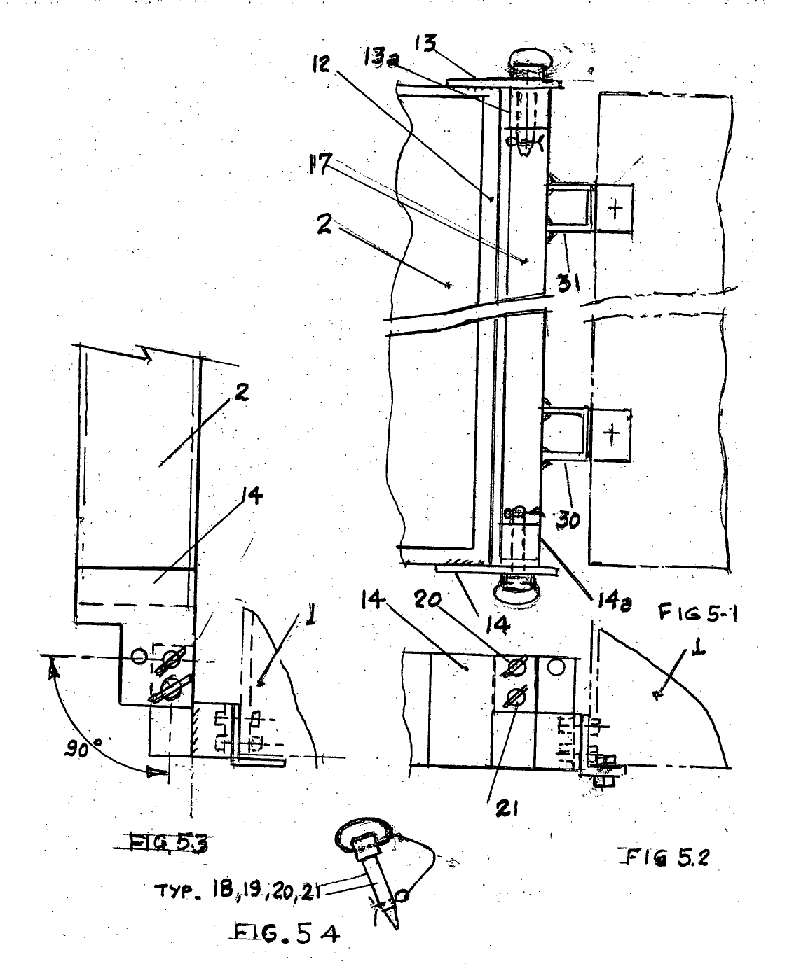

FIG. 5-1 shows a top view of the connecting assembly with its welded brackets 30 & 31 and the platform front side plates 13 & 14 which are connected by hitch pins.

FIG. 5-2 shows an elevation of view 5-1 with a connection for a horizontal setting for transportation of cargo.

FIG. 5-3 shows a similarly elevated view with a rearrangement of the matching holes and connecting hitch pins to obtain a vertical position with a security latch.

FIG. 5-4 shows the standard pullout hitch pin detail such as typical hitch pins 18, 19, 20 & 21.

Sheet 6 Shows an Auxiliary Use of the Platform

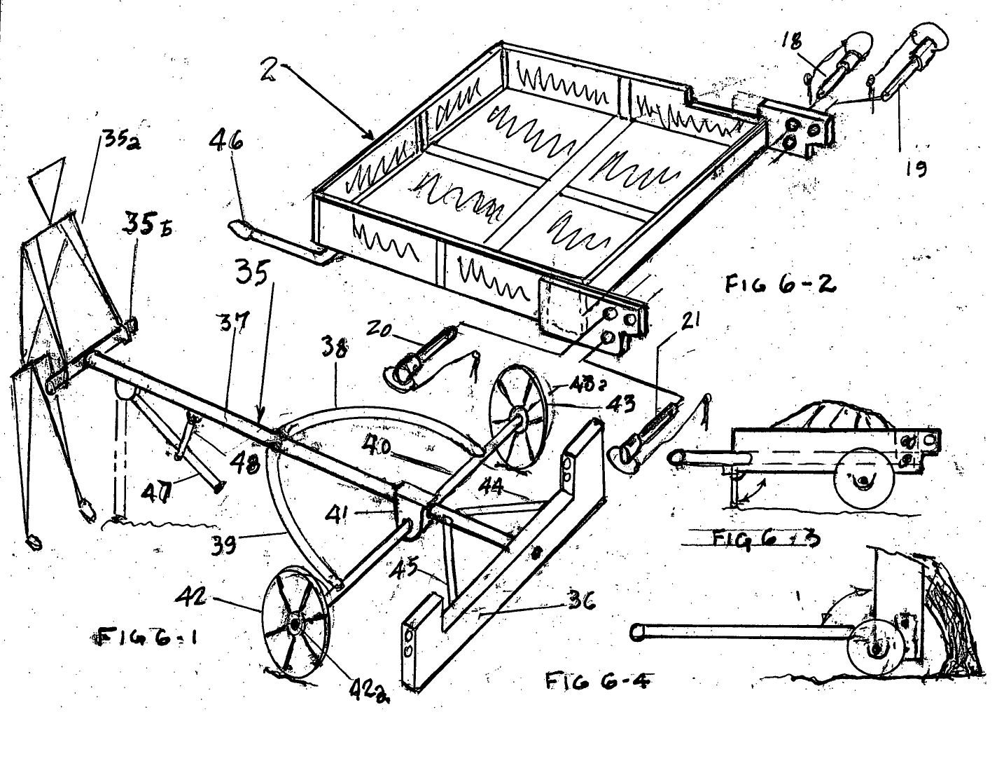

FIG. 6-1 shows an exploded perspective of a manually driven cart. The cart is constructed with a partial hitch bar 36 welded to a tubular frame 35. This consists of a central member 37 and two tubular arched bracing members 38 & 39. Member 37 also supports a 90° cross tubing 40 that is welded to a common bracket 41, with two braces 44 & 45, also welded between tube 37 onto hitch bar 36. Tube 40 also carries bearings and two wheels 42 & 43, centered at two extremities of 40, retained by two E rings 42a & 43a. An articulated leg 47 can be stored on a welded hook 48. As the platform is lowered, leg 47 is pulled perpendicular to the tube 37 and allows a stable resting position, resting on 3 points, the leg 47 and the two wheels 42 and 43.

FIG. 6-2 shows the platform 2, with the hitch pins at each end ready to be sub-assembled to the cart 35. The handle 46 is fastened to the right side of the front of the bottom of the platform.

FIG. 6-3 shows a side view of the cart and platform assembly with a load of dirt that is ready for transport.

FIG. 6-4 shows the versatility of the cart, which by removing one hitch pin 19e on each side, allows it to be pivoted manually, through handle 46 and the platform in a vertical position, can rapidly dump the cargo material.

1. A constructed cargo carrier to be mounted to a hitch bar bolted to the rear of the vehicle comprised of:
a hitch bar set parallel to the rear vehicle chassis;
a hitch bar having two rising bosses, one at each end, with each end pierced with two sets of longitudinal holes aligned from boss to boss;
a self-contained platform, made of light structural material, such as small steel tubing and a small steel rod, light enough and adequately sized for one person to handle;
a platform with two sides ending in the front with two side plates, one on each side, pierced with three holes, each set in line with the other and equally spaced;
a hole spacing and size arrangement such that the ones of the hitch bar and the ones of the plate fit each other, as the plates are taken in any two of the hole combinations the platform can be attached in either a parallel or vertical mode;

2. A light cargo carrier as described in claim 1, made of an open top with a tubular welded frame having three grills, one welded to the bottom of the frame in the front and two individually hinged in the rear on the center of the bottom of the frame which can be folded back on the front and latched, to provide a clear visual path as the platform is set vertically;

3. A light cargo carrier as described in claim 1 & 2, which has a versatile platform positioning arrangement allowing it to be set against the back of the vehicle when not in use, to ease the parking and driving facility;

4. A light cargo carrier, capable of being handled by one person, as described in claim 1 & 2 which also can be removed and stored;

5. A car platform, as described in claims 1, 2 & 3 that can also be used as an auxiliary with a constructed cart having two wheels and a long arm to help with manual transport of bulk material;

6. A car platform, as described in claims 1, 2 & 3 which can be pivoted on the hitch bar by removing one hitch pin from each side for quick disposal;
